(19) United States
(12) Patent Application Publication
(10) Pub. No.: US 2005/0120603 A1
(43) Pub. Date: Jun. 9, 2005

(54) Ad device having a changing board

(76) Inventor: Seung-Mok Paek, Seoul (KR)

Correspondence Address: Robert E. Bushnell, Suite 300, 1522 K Street, N.W., Washington, DC, 20005, US

(21) Appl. No.: 10/772,368

(22) Filed: Feb. 6, 2004

(30) Foreign Application Priority Data
Dec. 5, 2003 (KR) 2003-87918

(51) Int. Cl. G09F 7/00

(52) U.S. Cl. 40/492

(57) ABSTRACT

An ad device having a changing board including a plurality of flaps, which can express at least two advertisements to the front and behind faces of the plurality of ad flaps. The plane figure of each ad flap is an isosceles triangle. A supporting step is provided to make the changing board flat when the ad flaps are overlapped with neighboring ad flaps in an edge portion. An additional board may be provided to show another advertisement when the flaps are vertical stands. Accordingly, it is possible to maintain more exactly the horizontal state and the vertical state of the ad device and it is possible to prevent dust or foreign substances from entering into the ad device by having no gap between ad flaps.

### CLAIM OF PRIORITY

This application makes reference to, incorporates the same herein, and claims all benefits accruing under 35 U.S.C. §1.19 from an application for AD DEVICE HAVING A CHANGING BOARD earlier filed in the Korean Intellectual Property Office on 5 Dec. 2003 and there duly assigned Serial No. 2003-87918.

### BACKGROUND OF THE INVENTION

1. Field of the Invention

The present invention relates to an ad device having a changing board, more precisely to an ad device which can express at least two advertisements to the front and behind faces of a plurality of ad flaps.

2. Description of the Prior Art

Generally, a billboard that is attached and installed to a wall is composed of a plate, of which only one face is exposed outside. Accordingly, in order to place two advertisements, two billboards are required.

In Korea Patent No. 324430 incorporated herein by reference, the applicant had suggested the ad device, of which the sector gear is installed to the hinge axis of the plurality of ad flaps that are hinge-coupled with the frame for rotating the plurality of ad flaps into the front and behind directions and each sector gear is engaged with the flexible rack, whereby the front or behind face of the ad flaps are exposed outside according to the moving direction of the flexible rack. Accordingly, it is possible to alternately express two advertisements by selectively exposing a face of each ad flap to the outside. However, a gap between the ad flaps is generated because each ad flap is cornerwise stood after the rotation has done. Therefore, the content of the advertisement cannot be expressed well because it is stood counterclockwise, and each ad flap and the inside of the wall can easily be polluted because foreign substances enter through the gap.

### SUMMARY OF THE INVENTION

It is therefore an object of the present invention to provide an improved ad device.

It is another object to provide an improved ad device having a changing board which can express at least two advertisements to front face and behind face of each ad flap.

It is further an object to provide an improved ad device which can better communicate the advertisement content that is shown to the front faces and the behind faces of the ad flaps and a billboard attached on the frame of the ad device.

An ad device having features of the present invention includes a plurality of flaps, each of the flaps comprising a first face, a second face, and a first support supporting a turn of the flap, wherein the first face, the second face and the first support make an isosceles triangle shape in a plane view, the first support having a first step and a second step to receive edges of neighboring flaps; a plurality of hinge axes, each of the plurality of hinge axes coupled to each of the first supports; a plurality of first pinions, each of the first pinions mounted on each of the hinge axes; a rack engaged with the plurality of first pinions, the plurality of flaps turning on each of the hinge axes according to a movement of the rack so that the first and second faces can be alternately exposed to an outside according to a position of the rack.

It is preferred that a surface of the first or second faces when the ad device lies down is flat as a whole. The rack is preferably a mass body in a stick form. The ad device may further include a couple of first magnets mounted on both edges of the rack; and a couple of second magnets fixed to the ad device in a position corresponding to the first magnets, whereby the first magnet and the second magnet are coupled to each other to prevent a movement of the plurality of flaps as soon as the plurality of flaps finish turning. The ad device preferably further includes a second support mounted between the plurality of first pinions and the plurality of flaps, the second support having a plurality of the first bearings, each of the hinge axes passing through each of the first bearings; and a plurality of rolling bearings mounted on a bottom of the rack. The ad device may be installed on a side of a bus, wherein the movement of the rack may be caused by an external force such as an inertia force and an air resistance.

In another preferred embodiment, the rack is a chain type transmitting rack connected to a static driving motor through a second pinion of the static driving motor, and a driving force of the static driving motor is transferred to a movement of the first pinions through the second pinion and the rack. With this embodiment, it is possible that the first advertisement of the first face, a third advertisement on a billboard fixed on a frame of the ad device and the second advertisement of the second face are alternately shown. If the ad device further includes a controller, three advertisements maybe automatically and periodically exposed to the public in accordance with the controller signal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a perspective view of an embodiment according to the present invention;

FIG. 2A shows a front view of an embodiment of the present invention in a state where a first advertisement on a first face of each flap is shown to the public;

FIG. 2B shows a front view of an embodiment of the present invention in a state where a second advertisement on a second face of each flap is shown to the public;

FIG. 3A shows a plane view of an embodiment of the present invention in a state where the first advertisement on the first face of each flap is shown to the public;

FIG. 3B shows a plane view of an embodiment of the present invent in a state where the second advertisement on the second face of each flap is shown to the public;

FIG. 4A illustrates an embodiment of the present invention which is mounted on a side of a bus and which shows a state where the first advertisement on the first face of each flap is shown to the public;

FIG. 4B illustrates an embodiment of the present invention which is mounted on a side of a bus and which shows a state where the second advertisement on the second face of each flap is shown to the public;

FIG. 5 shows a perspective view of another embodiment of the present invention;

FIG. 6A shows a front view of another embodiment of the present invention in a state where the first advertisement on the first face of each flap is shown to the public;

FIG. 6B shows a front view of another embodiment of the present invention in a state where an advertisement on a fixed board is shown to the public;

FIG. 6C shows a front view of another embodiment of the present invention in a state where the second advertisement on the second face of each flap is shown to the public;

FIG. 7A shows a plane view of another embodiment of the present invention in a state where the first advertisement on the first face of each flap is shown to the public;

FIG. 7B shows a plane view of another embodiment of the present invention in a state where the advertisement on the fixed board is shown to the public; and

FIG. 7C shows a plane view of another embodiment of the present invention in a state where the second advertisement on the second face of each flap is shown to the public.

### DESCRIPTION OF THE PREFERRED EMBODIMENTS

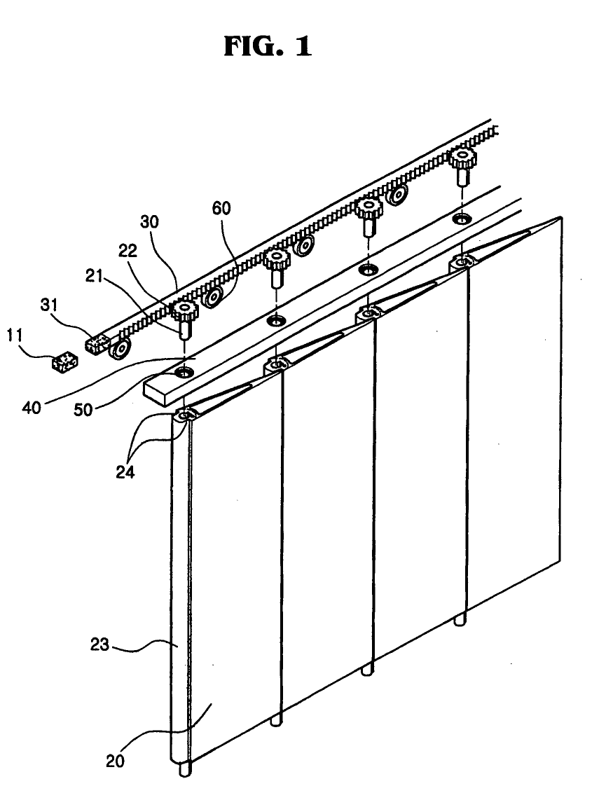

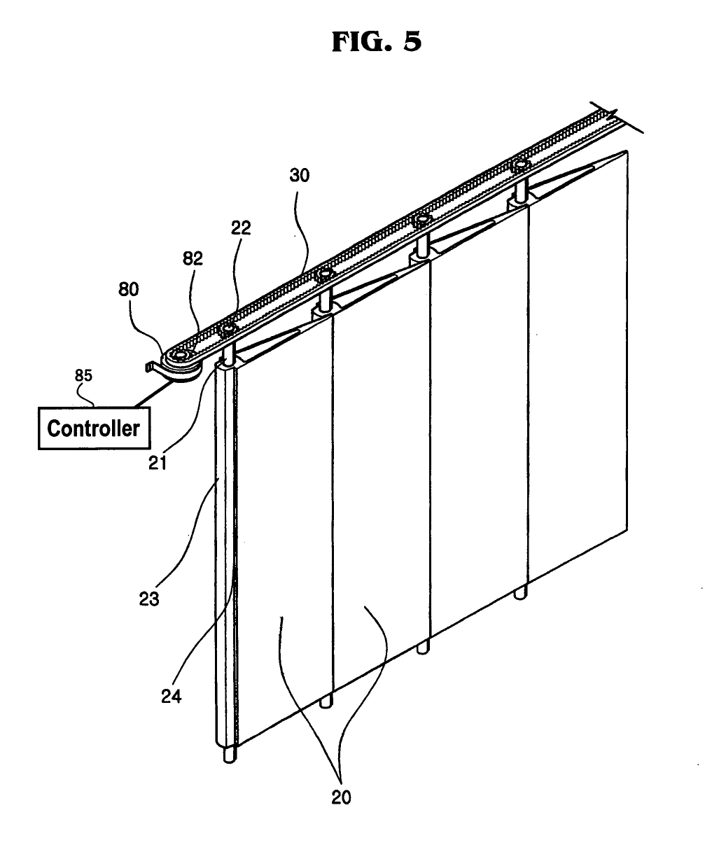

FIG. 1 through FIG. 4B show a preferred embodiment of the present invention and FIG. 5 through FIG. 7C show another preferred embodiment of the present invention.

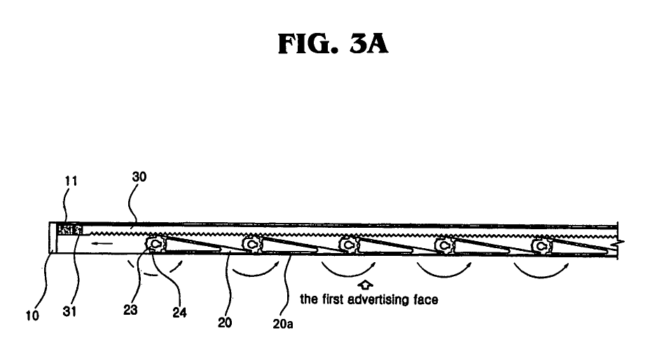

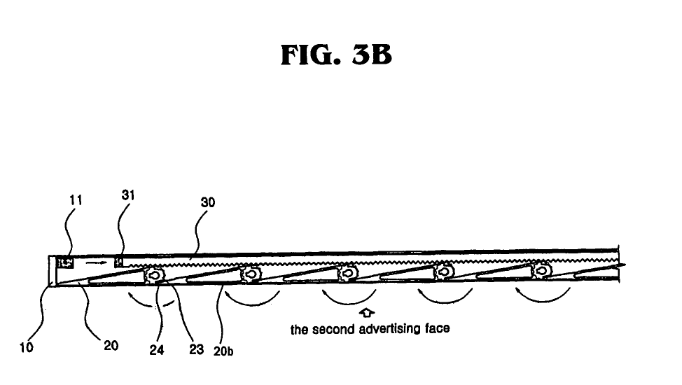

An ad device of the present invention preferably includes a frame 10. In the frame 10, a changing board which contains advertisements is mounted. The changing board is comprised of a plurality of flaps 20. Each flap 20 has a first face 20a and a second face 20b which contain the first and second advertisements, respectively. Each flap 20 has a flap support 23 which is coupled to a pinion 22 by a hinge axis 21. The first face 20a, the second face 20b, and the flap support 23 make preferably a trigonal prism shape whose plane view is an isosceles triangle shape. A supporting step 24 is installed on the front and the behind of the flap support 23 to receive a portion of the neighboring flaps. Accordingly, where the flaps 20 lie down in either direction, the exposed surface of the changing board is flat as shown in FIGS. 3A and 3B.

The pinion 22 is engaged with a rack 30. A movement of the rack 30 is transmitted to the pinion 22 so that each flap 20 is rotated according as the pinion 22 is rotated. Thus, both faces of each flap 20 may be alternately exposed to the outside according to the moving direction of the rack 30. Alternatively, instead of moving the rack 30, it is possible to move only pinions engaged with a fixed rack.

The embodiment of the present invention as shown in FIG. 1 through FIG, 4B may automatically change the advertising face by inertia even without power supply. The rack 30 is preferably made of a heavy weight stick. It is preferred that transmitting magnets 31 are mounted on both edges of the rack 30, and fixed magnets 11 corresponding to the transmitting magnets 31 are installed to both sides of the frame 10 for preventing the flaps 20 from moving when the flaps 20 completely lie down.

Preferably, a support bar 40 is mounted between the pinions 22 and the flaps 20. The support bar 40 has a plurality of thrust bearings 50 through which the hinge axis 21 passes to the support 40. A plurality of driving (or rolling) bearings 60 is mounted on the bottom of the rack 30.

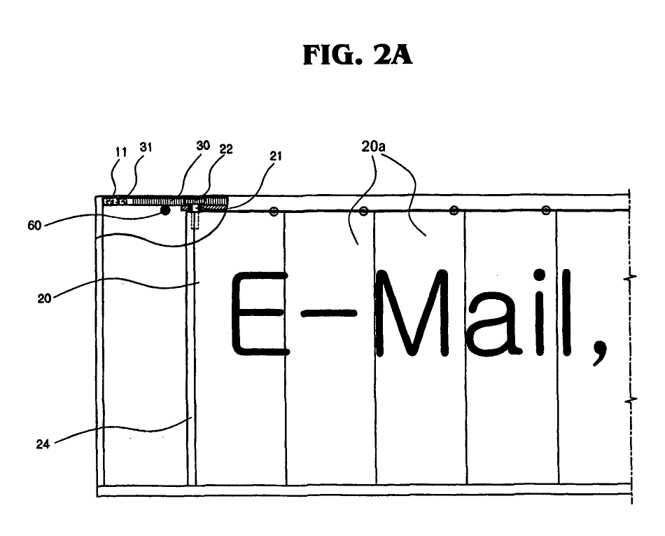

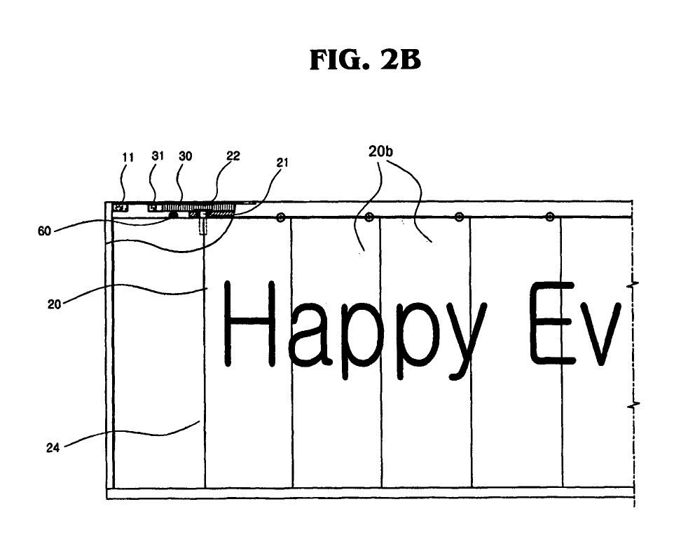

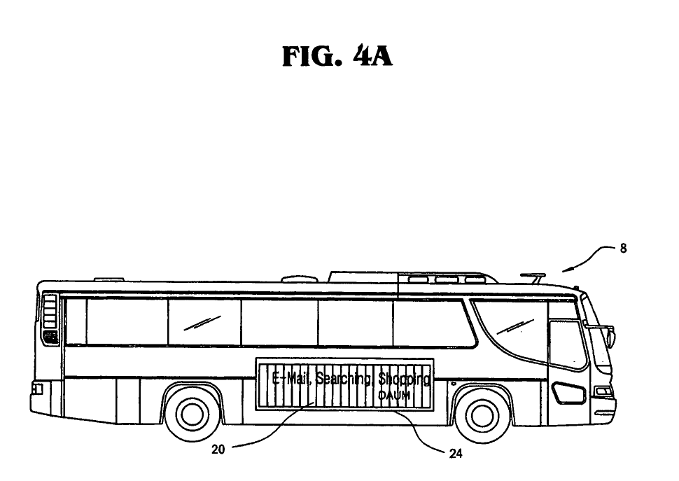

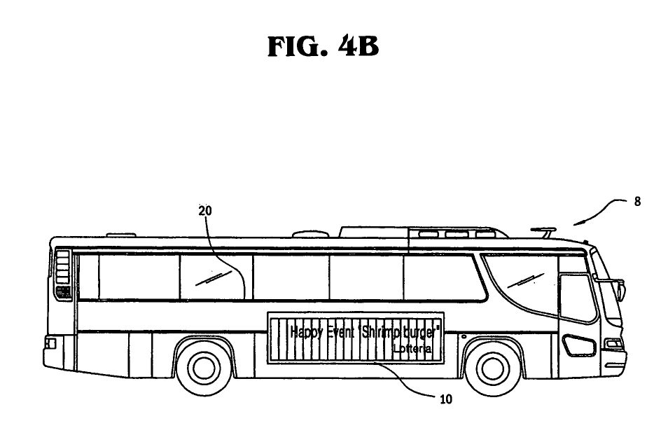

As shown in FIGS. 4A and 4B, if this device is fixated to the side of a bus, the rack 30 is positioned as shown in FIG. 2A and a first advertisement on the first face 20a is exposed when the bus is running. When the bus stops, the rack 30 moves to the position as shown in FIG. 2B by the inertia force and the air resistance that is generated when the bus stops, and each flap 20 is rotated clockwise by 180 degree. Accordingly, as shown in FIGS. 2B, 3B and 4B, a second advertisement on the second face 20b is shown. When the bus starts, the rack positioned as shown in FIG. 2B moves back to the position as shown in FIG. 2A by the inertia force and the air resistance, and each ad flap (20) is rotated counterclockwise by 180 degrees. Accordingly, as shown in FIGS. 2A, 3A and 4A, the first advertisement is shown.

FIGS. 5 through 7C show another embodiment of the present invention. In this embodiment, the device may be installed to the wall of the building or the other fixed wall. The rack 30 is preferably made as a chain type using a flexible material such as rubber. A driving pinion 82 of a static driving motor 80 is connected to the whole face of an inner portion of the rack 30. The driving of the static driving motor 80 may be controlled by a controller 85.

Preferably, a fixed billboard 90 is installed on the whole face of an inner portion of the frame 10.

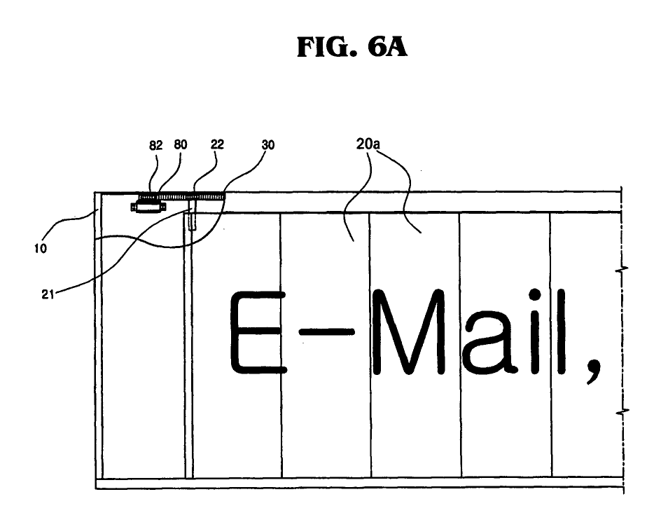

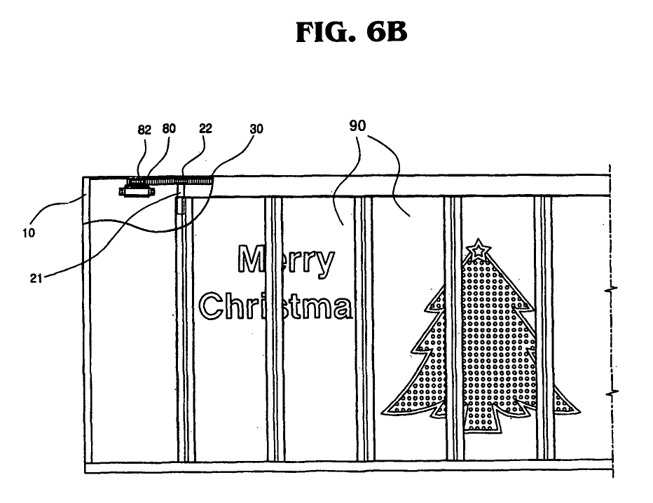

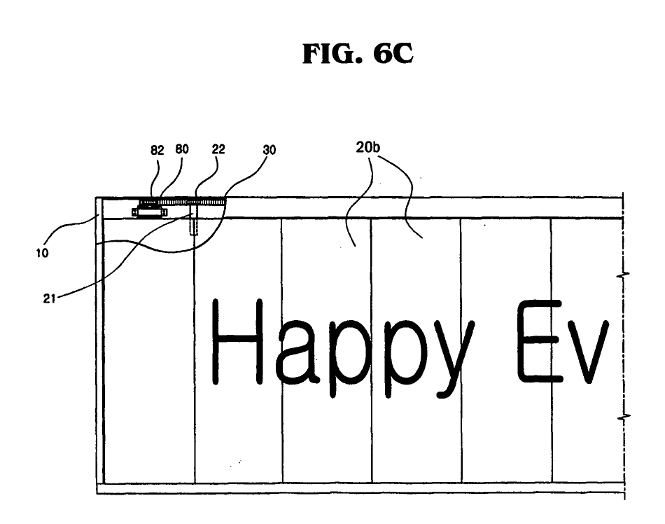

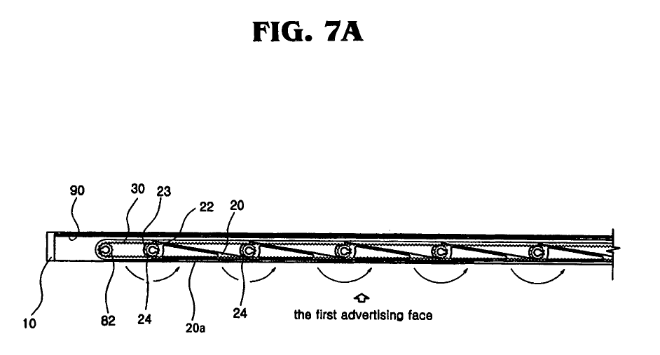

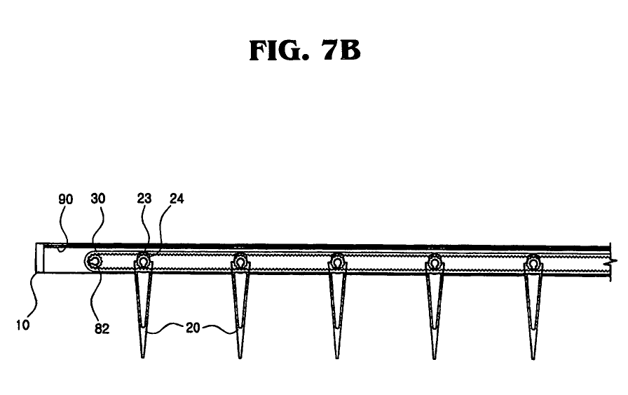

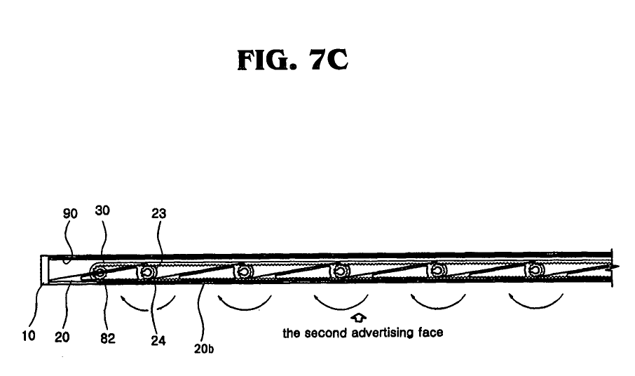

When each flap 20 is positioned as shown in FIGS. 6A and 7A, the first advertisement on the first face 20a is exposed to the outside. When each flap 20 moves clockwise from the position as shown in FIGS. 6A and 7A and is vertical stands as shown in FIGS. 6B and 7B, it is possible to show a third advertisement on the fixed billboard 90. From the position as shown in FIGS. 6B and 7B, each flap 20 further moves clockwise and is horizontally positioned as shown in FIGS. 6C and 7C, the second advertisement on the second face 20b of the flap 20 is exposed to the outside.

Accordingly, as shown in FIGS. 6A and 7A, FIGS. 6B and 7B, FIGS. 6C and 7C, it is possible that the first advertisement of the first face 20a, the third advertisement of the fixed billboard 90 and the second advertisement of the second face 20b are alternately shown in accordance with the controller signal.

As stated above, since the plane figure of each ad flap 20 is an isosceles triangle and the supporting step 24 is formed on the front and the behind of the flap support 23 to the front and the behind of the flap support 23, the edge on the first or second face of each ad flap 20 is upheld by the neighboring supporting step 24. Therefore, dust or foreign substance is prevented from entering into the inner of the frame 10 because there is no gap between flaps 20. Therefore, it is possible to make its appearance beautiful and to largely enhance the durability and the merchantability of the ad device.

Although the preferred embodiments of the present invention have been described, it will be understood by those skilled in the art that the present invention should not be limited to the described preferred embodiment, but various changes and modifications can be made within the spirit and scope of the present invention as defined by the appended claims.

1. An ad device, comprising:
a plurality of flaps, each of said flaps comprising a first face, a second face, and a first support supporting a turn of each said flap, wherein said first face, said second face and said first support make an isosceles triangle shape in a plane view, said first support having a first step and a second step to receive edges of neighboring flaps;
a plurality of hinge axes, each of said plurality of hinge axes coupled to each of said first supports;
a plurality of first pinions, each of said first pinions mounted on each of said hinge axes; and
a rack engaged with said plurality of first pinions, each of said plurality of flaps turning on each of said hinge axes according to a movement of said rack, whereby said first and second faces can be alternately exposed to an outside according to a position of said rack.

2. The ad device of claim 1, wherein said rack is a mass body in a stick form.

3. The ad device of claim 1, further comprising:
a couple of first magnets mounted on both ends of said rack; and
a couple of second magnets fixed to said ad device in a position corresponding to said couple of first magnets, whereby said first magnets and said second magnets are coupled to each other to prevent a movement of said plurality of flaps as soon as said plurality of flaps finish turning.

4. The ad device of claim 1, further comprising:
a second support mounted between said plurality of first pinions and said plurality of flaps, said second support having a plurality of said thrust bearings, each of said hinge axes passing through each of said thrust bearings; and
a plurality of rolling bearings mounted on the bottom of said rack.

5. The ad device of claim 1, wherein said rack is a chain type transmitting rack having teeth on an inner part of said rack.

6. The ad device of claim 5, further comprising:
a motor; and
a second pinion coupled to said motor, said second pinion engaged with said teeth of said rack to transfer a driving force of said motor to said plurality of flaps through said rack and said first pinions.

7. The ad device of claim 6, further comprising:
a controller controlling said motor.

8. The ad device of claim 7, wherein said motor is a static driving motor.

9. The ad device of claim 6, further comprising a board attached on said ad device, wherein said turn of said flaps comes to a standstill at three positions including a first position to show said first face, a second position to show said second face and a third position to show said board.

10. The ad device of claim 9, further comprising a controller to control said motor.

11. The ad device of claim 10, wherein said controller controls said motor to periodically show one of said first face, said board and said second face.

12. The ad device of claim 5, wherein said rack is made of rubber.

13. An ad device, comprising:
a frame;
a changing board comprising a plurality of flaps mounted in said frame, each of said flaps comprising a first face, a second face, and a first support supporting a rotation of said flap, said first face, said second face and said first support making an isosceles triangle shape in a plane view, said each flap being able to rotate a full half circle, said first support having a first step and a second step receiving edges of neighboring flaps to make an exposed surface of said changing board flat;
a plurality of hinge axes, each of said plurality of hinge axes coupled to each of said first supports;
a plurality of first pinions, each of said first pinions mounted on each of said hinge axes;
a rack engaged with said plurality of first pinions, said each flap rotating on each of said hinge axes according to a movement of said rack;
a couple of first magnets mounted on both ends of said rack; and
a couple of second magnets fixed to said frame in a position corresponding to said couple of first magnets, whereby said first magnets and said second magnets are coupled to each other to prevent a movement of said plurality of flaps as soon as said plurality of flaps finish rotating.

14. The device in claim 13, wherein said rack is a mass body in a stick form.

15. The ad device of claim 13, further comprising:
a second support mounted between said plurality of first pinions and said plurality of flaps, said second support having a plurality of thrust bearings, each of said hinge axes passing through each of said thrust bearings; and
a plurality of rolling bearings mounted on the bottom of said rack.

16. An ad device, comprising:
a frame;
a changing board comprising a plurality of flaps mounted in said frame, each of said flaps comprising a first face, a second face, and a first support supporting a rotation of said flap, said first face, said second face and said first support making an isosceles triangle shape in a plane view, said each flap being able to rotate a full half circle, said first support having a first step and a second step receiving edges of neighboring flaps to make an exposed surface of said changing board flat;
a plurality of hinge axes, each of said plurality of hinge axes coupled to each of said first supports;
a plurality of first pinions, each of said first pinions coupled to each of said hinge axes;
a rack having teeth on an inner side of said rack, said teeth engaged with said plurality of first pinions, each of said plurality of flaps rotating on each of said hinge axes according to a movement of said rack;
a second pinion engaged with said teeth of said rack;
a motor coupled to said second pinion, whereby a driving force of said motor is transferred to said first pinions through said second pinion and said rack to rotate said plurality of flaps; and
a board mounted within an frame, wherein said flaps come to a standstill at positions comprising a first position to show said first face, a second position to show said second face, and a third position to show said board.

17. The ad device of claim 16, further comprising:
a controller controlling said motor.

18. The ad device of claim 17, wherein said controller controls said motor to periodically show one of said first face, said billboard, and said second face.

19. The ad device of claim 18, wherein said rack is made of rubber.
